(19) United States
(12) Patent Application Publication
(10) Pub. No.: US 2014/0100913 A1
(43) Pub. Date: Apr. 10, 2014

(54) BUSINESS CONTINUITY AND RESPONSE PLAN MANAGEMENT

(71) Applicants: Cynthia Backer, High Ridge, MO (US); Mandeep Sandhu, O'Fallon, MO (US); Helena van Zanten, O'Fallon, MO (US); Kim Bowker, Wentzville, MO (US); Abby Wise, White Plains, NY (US); Hubert Pulley, Saint Louis, MO (US)

(72) Inventors: Cynthia Backer, High Ridge, MO (US); Mandeep Sandhu, O'Fallon, MO (US); Helena van Zanten, O'Fallon, MO (US); Kim Bowker, Wentzville, MO (US); Abby Wise, White Plains, NY (US); Hubert Pulley, Saint Louis, MO (US)

(73) Assignee: MASTERCARD INTERNATIONAL, INC., Purchase, NY (US)

(21) Appl. No.: 13/646,252

(22) Filed: Oct. 5, 2012

(51) Int. Cl. G06Q 10/06

(52) U.S. Cl. 705/7.28

(57) ABSTRACT

Embodiments described herein include are directed to managing response plans of an enterprise. Business recovery plans, system recovery plans, and emergency management plans for the enterprise are identified, where the business recovery plans relating to business aspects of the enterprise, the system recovery plans relating to technology aspects of the enterprise, and the emergency management plans relating to emergencies affecting the enterprise. The business recovery plans, system recovery plans, and emergency management plans are evaluated and plan metrics for the business recovery plans, system recovery plans, and emergency management plans are calculated independently and separately from each other. The plan metrics are calculated in response to the evaluation of the business recovery plans, the system recovery plans, and the emergency management plans. A readiness of the business recovery plans, the system recovery plans, and the emergency management plans is determined based on the evaluation.

### BACKGROUND

1. Field of the Disclosure

The present disclosure relates to the field of business operations. More particularly, disclosed is a system and method for managing one or more plans to be implemented by a business in response to a disruption to normal operations which would permit the business to recover its operational status to a normal state from the effects of such a disruption.

2. Brief Discussion of Related Art

Corporations and other organizations can be adversely affected by circumstances or events, which disrupt their operations. Response to and recovery from these events can require certain levels of planning and courses of action. Typically, corporations implement business continuity plans to provide a series of steps that can be followed to recover after an event that disrupts the business related aspects of the corporation occurs. These business continuity plans often fall short of the comprehensive integrated approach necessary to ensure overall readiness and resiliency.

### SUMMARY

In one aspect, a method for managing response plans of an enterprise is disclosed. The method includes identifying business recovery plans, system recovery plans, and emergency management plans for the enterprise. The business recovery plans relate to business aspects of the enterprise. The system recovery plans relate to technology aspects of the enterprise. The emergency management plans relate to the response and management of emergencies affecting the enterprise. The method also includes evaluating the business recovery plans, system recovery plans, and emergency management plans and calculating plan metrics for the business recovery plans, system recovery plans, and emergency management plans independently and separately from each other. The plan metrics are calculated in response to an evaluation of the business recovery plans, the system recovery plans, and the emergency management plans. The method further includes determining a readiness of the business recovery plans, the system recovery plans, and the emergency management plans based on the evaluation.

In another aspect, a computer readable medium storing instructions executable by a computing system including at least one computing device is disclosed. The method implemented by the execution of the instructions includes identifying business recovery plans, system recovery plans, and emergency management plans for the enterprise. The business recovery plans relate to business aspects of the enterprise. The system recovery plans relate to technology aspects of the enterprise. The emergency management plans relate to emergencies affecting the enterprise. The method implemented by the execution of the instructions also includes evaluating the business recovery plans, system recovery plans, and emergency management plans and calculating plan metrics for the business recovery plans, system recovery plans, and emergency management plans independently and separately from each other. The plan metrics are calculated in response to an evaluation of the business recovery plans, the system recovery plans, and the emergency management plans. The method implemented by the execution of the instructions further includes determining a readiness of the business recovery plans, the system recovery plans, and the emergency management plans based on the evaluation.

In yet another aspect, a system managing response plans of an enterprise is disclosed. The system includes a computing system including at least one computing device. The computing system is configured to identify business recovery plans, system recovery plans, and emergency management plans for the enterprise. The business recovery plans relate to business aspects of the enterprise. The system recovery plans relate to technology aspects of the enterprise. The emergency management plans relate to emergencies affecting the enterprise. The computing system is also configured to generate an evaluation schema for the business recovery plans, system recovery plans, and emergency management plans and to calculate plan metrics for the business recovery plans, system recovery plans, and emergency management plans independently and separately from each other. The plan metrics are calculated in response to an evaluation of the business recovery plans, the system recovery plans, and the emergency management plans. The computing system is further configured to determine a readiness of the business recovery plans, the system recovery plans, and the emergency management plans based on the evaluation.

In some embodiments, the business recovery plans, system recovery plans, and/or the emergency recovery pans can be filtered using a plan filter. The filtering can be based on plan parameters associated with the business recovery plans, system recovery plans, and/or emergency management plans. The filtering can exclude a portion of the business recovery plans, system recovery plans, and/or emergency management plans from the calculation of plan metrics.

In some embodiments calculating plan metrics for the system recovery plans can include identifying evaluation results for system recovery plans that have not been excluded by the plan filter, classifying a number of system recovery plans identified as recovery ready based on the evaluation results, classifying a number of system recovery plans identified as workable based on the evaluation results, classifying a number of system recovery plans identified as not recovery ready based on the evaluation results, and calculating a percentage of system recovery plans that are recovery ready, workable, and not recovery ready using the system recovery plans that have not been excluded by the plan filter.

In some embodiments evaluating the business recovery plans, system recovery plans, and/or emergency management plans can include generating evaluation forms for the business recovery plans, system recovery plans, and/or emergency management plans, where the evaluation forms including questions, assigning a point values to the questions, and calculating plan scores for the business recovery plans, system recovery plans, and/or emergency management plans based on the point values received for the questions.

In some embodiments, ranges of plan scores that correspond to a designation of recovery ready, workable, and/or not recovery ready can be specified, and plan scores calculated for the business recovery plans, system recovery plans, and/or emergency management plans can be classified based on the ranges of plan scores.

In some embodiments, the plan metrics can be displayed as at least one of a chart, table, and graph and access to the plan metrics can be restricted based on a user level assigned to a user requesting access.

### BRIEF DESCRIPTION OF THE DRAWINGS

The above and other features, aspects and advantages of the instant disclosure will become apparent upon consideration of the following detailed description thereof, particularly when taken in conjunction with the accompanying drawings, wherein like reference numerals in the various figures are utilized to designate like components, and wherein

FIG. 1 depicts a block diagram of an exemplary enterprise recovery system;

FIG. 2 depicts an exemplary computing device for implementing embodiments of an enterprise recovery plan evaluation tool;

FIG. 3 depicts an exemplary computer system for implementing embodiments of the enterprise recovery system;

FIG. 4 illustrates an exemplary screenshot including an enterprise view generated by an evaluation tool according to the present disclosure;

FIGS. 5-9 illustrate various exemplary system recovery plan evaluation screenshots generated by an evaluation tool according to the present disclosure;

FIGS. 10-12 illustrate various exemplary administration screenshots useful to manage forms, uses and evaluations according to the present disclosure;

FIGS. 13-16 illustrate various exemplary business recovery plan evaluation screenshots generated by an evaluation tool according to the present disclosure;

FIGS. 17-19 illustrate various exemplary emergency management plan evaluation screenshots generated by an evaluation tool according to the present disclosure; and

FIG. 20 illustrates a flowchart showing an exemplary plan metrics analysis according to the present disclosure.

### DETAILED DESCRIPTION

Exemplary embodiments include an enterprise recovery system providing a comprehensive and integrated environment for managing, maintaining, creating, updating, organizing, and the like, response plans for business recovery, system recovery, and emergency management.

As used herein, an “enterprise” refers to an organization and/or entity, such as a corporation, partnership, joint venture, association, cooperative, and the like. “Business recovery” refers to recovering and/or reestablishing business aspects of an enterprise. “Emergency management” refers to event management and overall coordination of an enterprise responsive to one or more unusual or extraordinary events or stresses, until the circumstances and environment in which the enterprise operates returns to normal. “System recovery” refers to recovering and/or reestablishing technology based aspects of an enterprise including, for example, computing systems.

Embodiments of the enterprise recovery system can facilitate efficient management, evaluation, and implementation of response plans for an enterprise, including business recovery plans, system recovery plans, and emergency management plans to provide a comprehensive environment in which enterprise recovery readiness and coverage can be achieved.

A “business recovery plan” is a document that contains a procedure, process, steps, and the like, to be implemented to recover business related aspects of the enterprise upon the occurrence of a trigger event that impacts and/or disrupts the operation of business related aspects of the enterprise. Some exemplary trigger events can include natural catastrophes, manmade catastrophes, organized labor strikes, and the like. Business related aspects of the enterprise can include customer service, human resources, marketing, accounting, finance, payroll, sales, contracts, information technology, and the like.

A “system recovery plan” is a document that contains a procedure, process, steps, and the like, to be implemented to recover system related aspects of the enterprise upon the occurrence of a trigger event that impacts and/or disrupts the operation of system related aspects of the enterprise. Some exemplary trigger events can include natural catastrophes, manmade catastrophes, system failures, system attacks, and the like. System related aspects of the enterprise can include computing device failures, network failures, software failures, network attacks, network security breaches, and the like.

An “emergency management plan” is a document that contains a procedure, process, steps, and the like, to be implemented upon the occurrence of trigger event that impacts and/or disrupts the operation of specific regions, offices, and the like, of the enterprise. Some exemplary trigger events can include natural catastrophes, manmade catastrophes, emergencies and the like. Emergencies can include, for example, floods, explosions, fires, earthquakes, hurricanes, tornadoes, blizzards, natural or manmade disasters, terrorist attacks, and the like. Emergency management plans can include processes, procedures and templates to follow in response to an event including detailed contact information of entities that could support the enterprise responsive to the trigger event.

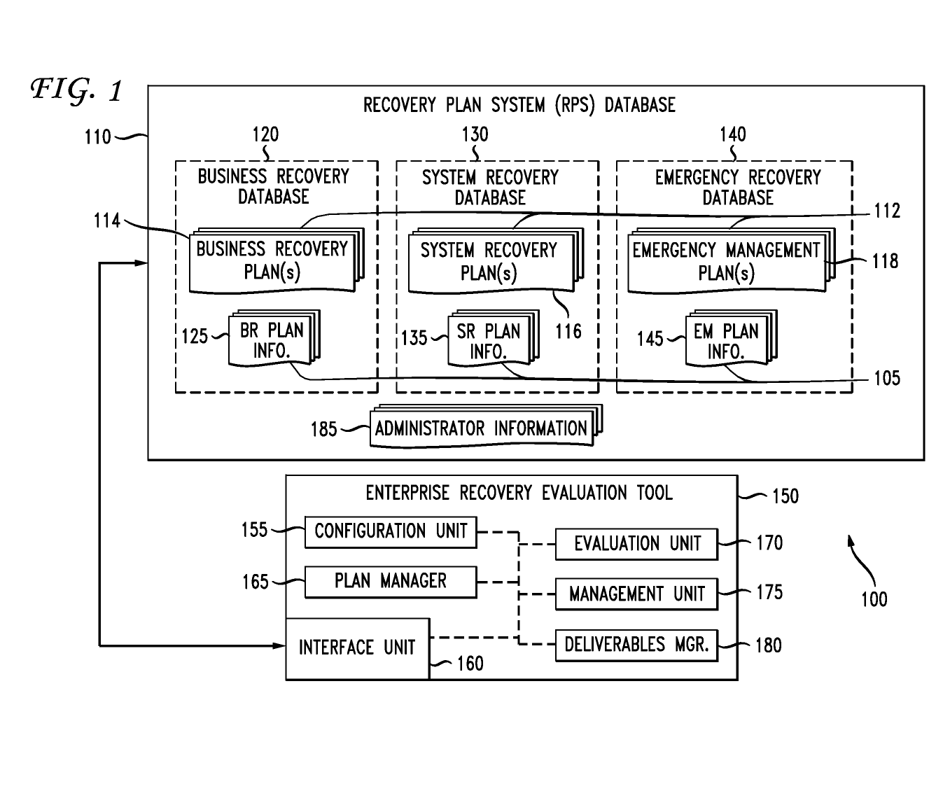

FIG. 1 depicts a block diagram of an enterprise recovery system 100 (hereinafter “system 100”) for facilitating management, monitoring, evaluation, and the like, of response plans generated by an enterprise. The system can include a Recovery Plan System or Response Plan System (interchangeably) database 110 (hereinafter RPS database 110) and an enterprise recovery evaluation tool 150 (hereinafter “tool 150”). In some embodiments the RPS database 110 can be a Living Disaster Recovery Plan System (LDRPS®) database from SunGard Systems.

The RPS database 110 provides a database that stores response plan information, such as response plans, generally 112, for the enterprise. The response plans 112 can include business recovery plans 114, system recovery plans 116, emergency management plans 118, and the like. The RPS database 110 can also include response plan information, generally 105, including business recovery (“BR”) plan information 125, system recovery (“SR”) plan information 135, or emergency management (“EM”) plan information 145. The depiction in FIG. 1 of a particular number of response plans 112, business recovery plans 114, system recovery plans 116, emergency management plans 118, response plan information 105, BR plan information 125, SR plan information 135, EM plan information 145 or administrator information 185 shall not preclude more or fewer of any of these within the scope of the present disclosure.

Plan information 105 generally may include, for example, plan parameters, deliverables, compliance with deliverables, and the like. Plan parameters can include, for example, an office type parameter, an office location parameter, a division parameter, a business unit parameter, a plan tier parameter, a plan identifier, a recover time objective parameter, a business service type parameter, a business services parameter, a business service criticality parameter, an overall plan category parameter, and the like. Response plans can have values associated with the plan parameters. The plan parameters allow the tool 150 to manage, monitor, and update response plan information. A deliverable can be an act, action, series or sequence of acts or actions, and/or an undertaking for completion.

In some embodiments, the RPS database 110 can be implemented as a single centralized database including business recovery, system recovery, and emergency management plan information. As one example, the RPS database 110 can organize information concerning the response plans 112, such as deliverables for the business recovery plans, users and/or teams associated with the business recovery plans, the business recovery plans themselves, deliverables for the system recovery plans, users and/or teams associated with the system recovery plans, the system recovery plans themselves, deliverables for the emergency management plans, users and/or teams associated with the emergency management plans, the emergency management plans themselves, and the like. Information in the RPS database 110 can be retrieved using database operations or procedures and/or plan identifiers that when specified can uniquely identify response plan information in the RPS database 110.

In some embodiments, the RPS database 110 can be implemented as multiple distributed databases. As one example, the RPS database 110 can be implemented as a business recovery database 120, a system recovery database 130, and an emergency recovery database 140 (each shown in broken line). The business recovery database 120 can store business recovery plans 114 and business recovery plan information 125 associated with business recovery plans 114. The system recovery database 130 can store system recovery plans 116 and system recover plan information 135 associated with system recovery plans 116. The emergency recovery database 140 can store emergency management plans 118 and emergency management plan information 145 associated with emergency management plans 118. Also shown in FIG. 1 is administrator information 185, as will be explained in further detail hereinafter. Administrator information 185 may be stored generally in the RPS database 110, or specifically in a distributed administrative database (not shown).

The tool 150 can include a configuration unit 155, an interface unit 160, a plan manager 165, an evaluation unit 170, a management unit 175, and a deliverables manager 180. The tool 150 can be implemented using one or more software and/or hardware components and can generate one or more graphical user interfaces (GUIs). Some examples of software components that can be used to implement, at least a portion of the tool 150, can include a Flex from Adobe, Inc., Spring from Spring Source a division of VMware, Inc., Hibernate from JBoss a division of Red Hat, Inc., Rational Application Developer (RAD) from IBM Corporation, Websphere from IBM Corporation, Oracle, Flex Builder, and the like.

The tool 150 can integrate business recovery plan information 125, system recovery plan information 135, and emergency management plan information 145 to facilitate a comprehensive enterprise recovery approach that can ensure enterprise recovery readiness when a trigger event occurs. The tool 150 can analyze response plan information to calculate plan metrics based on evaluation results and can generate one or more views to display the plan metrics. As used herein, a “plan metric” refers to a characterization of aspects of a response plan including, for example, recovery plan readiness, deliverables compliance, a distribution of recovery plans across plan parameters, and the like. A plan metric can be expressed using numbers, percentages, words, charts, graphs, tables, and the like. Using this approach, the enterprise can monitor and management response plan readiness across business, system, and emergency aspects of the enterprise.

In some embodiments, the components of the tool 150 can be implemented using one or more software operations, procedures, functions, and the like. Software procedures are software segments that can be implemented to perform functions and/or operations for storing data, retrieving data, maintaining data, displaying data, and the like. For example, the software procedures can store, retrieve, modify (e.g., add, delete, change), maintain, and/or display information stored in tables of the RPS database 110.

The configuration unit 155 can facilitate management and/or maintenance of users and user configurations. For example, the configuration unit 155 allows users to add, delete, and edit user profiles. The tool 150 can implement different user levels and can restrict access to functions and/or operations performed by the tool 150, as well as to information accessible using the tool 150. In some embodiments, the user levels that are implemented by the tool 150 can include an administrative user, an evaluator, and a restricted user. An “administrative user” is a user who has permission to control access to the system 100, add/delete evaluators and/or restricted users, define response plans, edit response plans, evaluate response plans, define deliverables, define evaluation criteria, and the like. An “evaluator” is a user who has permission to view and evaluate response plans. A “restricted user” is a user that can view response plans and evaluation results associated with the recovery plans. Access to the response plans, evaluation forms, evaluation results for the response plans, deliverables, and the like, can be restricted based on the user's level as well as the role of the restricted user, the office location of the restricted user, a title associated with the restricted user, and the like.

The configuration unit 155 can allow an administrative user to edit administrator information 185, such as a user name, password, user identification (ID), phone number, electronic mail (e-mail) address, office affiliation, user level, user role, and the like. Once a user has been added, the user can access the tool 150 by logging in using, for example, a user ID and password.

The interface unit 160 can provide an interface between the tool 150 and the RPS database 110. The interface unit 160 can be used by the tool 150 to access, retrieve, update, maintain, and/or deposit response plan information 105 in the RPS database 110. The interface unit 160 allows the tool 150 to generate real-time reports associated with response plans so that users of the tool 150 can monitor critical elements, such as, for example, response plan readiness, deliverables, deliverable compliance, and the like. In some embodiments, the tool 150 can be synchronized with the RPS database 110 to update the graphical user interfaces (GUIs) of the tool 150 so that the tool 150 uses up-to-date data stored in the RPS database 110 to generate and analyze reports associated with response plan information 105.

The plan manager 165 can be used to generate and maintain response plans. For example, the plan manager 165 can allow administrative users to generate a response plan and save the response plan in the RPS database 110. The administrative user can also update and/or modify response plans, and can archive response plans using version control. The plan manager 165 can associate a plan identifier with each response plan. The plan identifier can be used by the tool 150 to map the response plans to evaluation forms, evaluation results, plan information 105 such as deliverables, deliverable results, and the like. The mapping can be performed using tables, extensible mark-up language (XML) based documents, and the like. When new information 105 corresponding to a response plan 112 is entered into the RPS database 110, the information is automatically mapped to the corresponding response plan 112 so that the user of the system 100 can view the information as it relates to the response plan 112.

The plan manager 165 maintains plan versions so that when a response plan is modified or updated, the plan manager 165 can archive the previous version of the response plan and can include the newly modified or updated recovery as the latest version of the response plan. The plan manager 165 can also associate plan evaluations with the plans using, for example, the plan identifier and plan version. In this manner, the tool 150 can maintain up-to-date, real-time records of the response plans, evaluations of the response plans, deliverables for each of the response plans, and the like.

The evaluation unit 170 can allow users to generate evaluation criteria for the response plans and can allow users to evaluate the response plans using the generated evaluation criteria. Evaluation of the response plans using the evaluation criteria can be used to determine whether one or more of the response plans are recovery ready. For example, the evaluation unit can allow users to develop evaluation forms to be completed by response plan evaluators. The results from completion of the evaluation forms can be used to calculate a readiness score to be associated with a response plan. The readiness score of a response plan can be used to determine whether the response plan is recovery ready, workable, not recovery ready, and the like.

The evaluation unit 170 can allow users to specify a range of readiness scores to associate with different levels of readiness. For example, a user can specify a first range of readiness scores corresponding to a recovery ready range, a second range of readiness scores associated with a workable range, and a third range of readiness scores corresponding to a not recovery ready range. In some embodiments, the ranges of readiness scores can be specified separately for business recovery plans, system recovery plans, and emergency management plans such that the ranges of readiness scores for business recovery plans, system recovery plans, and/or emergency management plans can be different. In some embodiments, the ranges of readiness scores can be specified separately for individual response plans such the ranges of readiness scores for the recovery plans can be different.

In some embodiments, the evaluation forms can be implemented as a questionnaire having questions related to aspects of the response plan. Each question can be assigned a number of points and the readiness of the response plan can be determined based on the total number of the points accumulated after an evaluation of the response plan is performed, which can be referred to herein as the readiness score. In this manner, the questions can be weighted to facilitate a distribution of points based on, for example, an importance, priority, and/or other factor associated with the question.

The management unit 175 can organize response plan information 105 based on, for example, plan identifiers, evaluation results, deliverable requirements, and the like. For example, the management unit 175 can generate reports including charts, graphs, tables, and the like, based on the response plan parameters, evaluation results, deliverable requirements, deliverable compliance, and the like.

The management unit 175 can provide export operations that allow users to export response plan information 105. Some examples of export operations include an e-mail operation for e-mailing the response plans and/or response plan evaluations, a print operation for printing the response plans and/or response plan evaluations, an export to spreadsheet operation that allows the response plans and/or response plan evaluations to be exported to a spreadsheet application (e.g., Microsoft® Excel®), and the like.

The deliverables manager 180 can provide a multitude of operations that allow users to maintain and track deliverables required to maintain response plan information 105, with reference to a selectable time period, for example a year or a quarter. Some examples of deliverables under the purview of the deliverables manager 180 include Business Impact Analysis review/sign-off, exercise completions, plan reviews/updates, and Notification Testing. The deliverables manager 180 allows flexibility in assigning single or multiple deliverables for each response plan type.

The system 100, and more specifically, the tool 150 can maintain, track, and archive response plans, response plan evaluations and/or response plan deliverables throughout the response plan life cycle. Additionally, the system 100 can provide a comprehensive environment integrating business recovery plans, system recovery plans, and emergency management plans for efficient and effective management and review of response plans, response plan evaluations, and/or response plan deliverables for an enterprise.

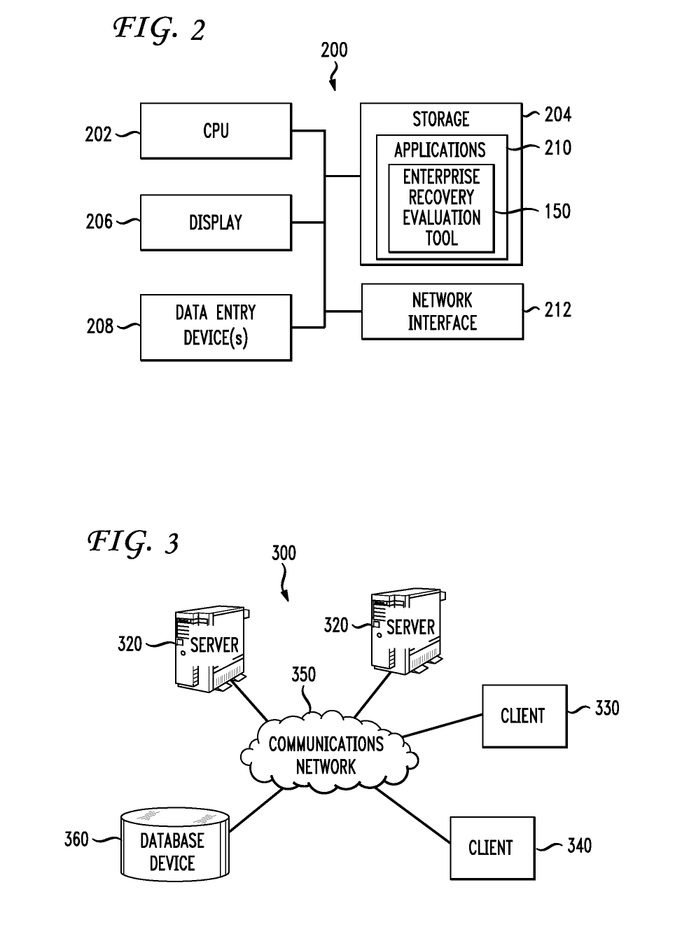

FIG. 2 depicts an exemplary computing device 200 for implementing embodiments of the tool 150 of the system 100 (FIG. 1). The computing device 200 can be a mainframe, personal computer (PC), laptop computer, workstation, handheld device, such as a PDA, or the like. In the illustrated embodiment, the computing device 200 includes a central processing unit (CPU) 202 and storage 204. The storage 204 can include computer readable medium technologies, such as a floppy drive, hard drive, compact disc, tape drive, Flash drive, optical drive, read only memory (ROM), random access memory (RAM), and the like. The computing device 200 can further include a display unit 206 and data entry device(s) 208, such as a keyboard, touch screen, microphone, and/or mouse.

Applications 210, such as the tool 150, can be resident in the storage 204. The storage 204 can include instructions for implementing the tool 150. The instructions can be implemented using, for example, C, C++, Java, JavaScript, Basic, Perl, Python, assembly language, machine code, and the like. The storage 204 can be local or remote to the computing device 200. The computing device 200 includes a network interface 212 for communicating with a communication network. The CPU 202 operates to run the applications 210 in storage 204 by executing instructions therein and storing data resulting from the performed instructions, which may be presented to a user. The data in the storage 204 can include, for example, response plans, response plan evaluations, deliverables for the response plans, user configuration information, and the like.

FIG. 3 depicts an exemplary computing system 300 for implementing embodiments of the enterprise recovery system 100 (FIG. 1). The computing system 300 includes one or more servers 310 and 320 coupled to clients 330 and 340, via a communication network 350, which can be any network over which information can be transmitted between devices communicatively coupled to the network including, for example, the Internet, an intranet, a virtual private network (VPN), Wide Area Network (WAN), Local Area network (LAN), and the like. The computing network 300 can also include repositories or database devices 360, which can be coupled to the servers 310/320 and/or clients 330/340 via the communications network 350. The database device 360 can be used to implement the RPS database. The servers 310/320, clients 330/340, and database devices 360 can be implemented using a computing device. The tool 150 can be implemented using a single computing device or can be implemented in a distributed manner using multiple computing devices. For example, the tool 150 can be implemented using one or more of the servers 310 and 320.

The servers 310/320, clients 330/340, and/or database devices 360 can store information, such as components of the tool 150, response plans, evaluations of response plans, deliverables for response plans, and the like. In some embodiments, the system 100 can be distributed among the servers 310/320, clients 330/340, and/or database devices 360 such that one or more components of the system 100 and/or a portion of one or more components of the system 100 can be implemented by a different device (e.g. clients, servers, databases) in the communication network 350.

For example, the tool 150 can be resident on the server 310 as a web application and the RPS database can be implemented using the database devices 360. In the present example, users can use the client devices 330 and 340 to access the system 100 using a client side application, such as a web browser, mobile phone widget, applet, or other client side application implemented on the client devices 330 and 340. The user can navigate to, for example, a Uniform Resource Identifier (URI) address, such as a Uniform Resource Locator (URL) address, at which the user can log on to the system 100.

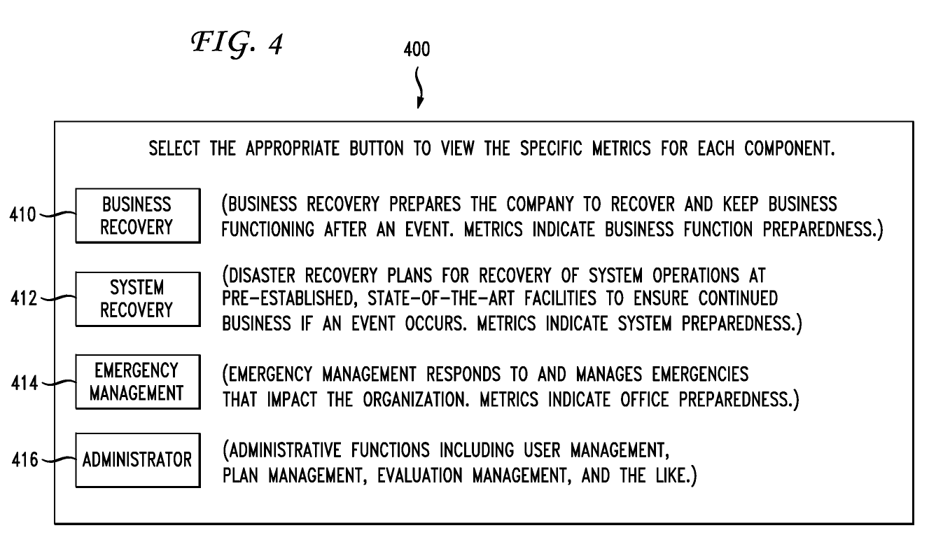

FIGS. 4-20 illustrate exemplary graphical user interfaces generated by the tool 150 (FIG. 1). In the present embodiment, the tool 150 is implemented as a web application. While the tool 150 can be implemented as a web application, those skilled in the art will recognize that the form in which the tool 150 is implemented can vary.

FIG. 4 illustrates an enterprise view 400 that can be generated by the management unit 175 of the tool 150 (FIG. 1). The enterprise view 400 includes buttons for selecting, reviewing and managing plan information. In the present embodiment, the enterprise view 400 can include a business recovery button 410, a system recovery button 412, an emergency management button 414, and an administrator button 416.

In some embodiments, one or more of the buttons 410, 412, 414, and/or 416 can be inaccessible to the user based on the user's associated user level (e.g., administrator, evaluator, restricted user), user role (e.g., executive, human resources, sales, accounting, etc.), office location (e.g., New York, London, St. Louis, etc.), office type (e.g., technology, sales, account management, etc.), and the like. For example, the user can be restricted from accessing response plan information 105 corresponding to business recovery plan information 125, system recovery plan information 135, emergency management plan information 145, and/or administrator information 185. In some embodiments, buttons that are not accessible by a user can be removed so that the buttons are not displayed to the user.

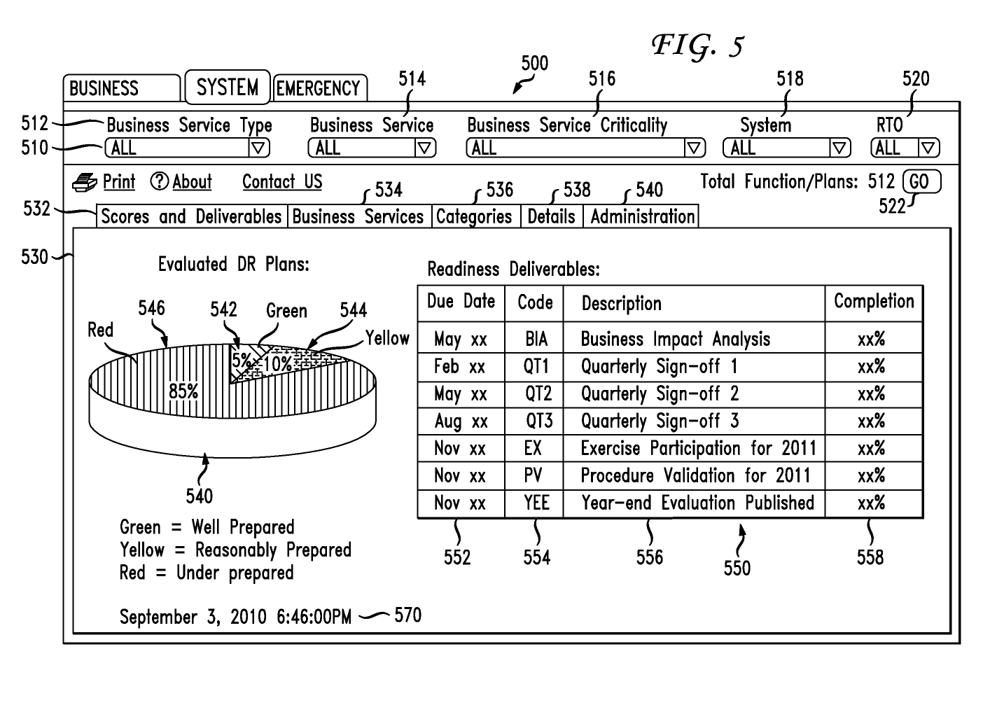

FIGS. 5-7 illustrate an exemplary system recovery view 500 that can be displayed when the system recovery button 412 is selected by the user. The system recovery view 500 displays system recovery plan information 135 and can include a plan filter 510 and sub view tabs 530. The plan filter 510 can be used to exclude system recovery plans from being included in system recovery plan analysis displayed in the system recovery view 500. The sub-view tabs 530 can include a scores and deliverables tab 532, a business services tab 534, a categorization tab 536, a details tab 538, and an administrative tab 540. The sub-view tabs 530 can be selected to display system recovery plan information 135 and analysis.

The plan filter 510 can filter response plans according to plan parameters, such as a business service type parameter 512, a business services parameter 514, a business service criticality parameter 516, a system parameter 518, and a recovery time objective (RTO) parameter 520. The user can specify values for some, all, or none of the plan parameters and can execute the plan filter 510 by selecting the button 522 to exclude system recovery plans that do not match the specified values for the plan parameters.

The business service type parameter 512 can include a general and/or primary function of the office. Business service types are high-level classification of a group of systems to a business. Some examples of business service type parameter 512 values can include Core Processing Services, Infrastructure Services, Product Services and Internal Services.

The business services parameter 514 describes classifications for one or more groups of related systems within a business service type 512. Business services parameter 514 values can include File Transfer, Billing, Authorization, Debit.

The business service criticality parameter 516 reflects a ranking of business services 514, for example as compared with others within a particular business service type 512. Business Service Criticality values can include Highly Critical, Critical, Moderate, etc.

The system parameter 518 describes an individual application or system within a Business Service. An example system parameter 518 may include Settlement Account Management, i.e., the system using settlement requests from eligible transaction processing systems to calculate member positions and generate transfer orders necessary to effect settlement; or Member Publications, i.e., a system containing business procedures and technical reference information that customers need.

By way of example only, the following table illustrates a set of interrelated system parameters 518, business service type parameters 512, business service parameters 514 and business service criticality parameters 516.

| | | | Business |
|---|---|---|---|
| | Business | | Service |
| System | Service Type | Business Service | Criticality |
| Settlement | Core Processing | Clearing/ | Highly |
| Account Mgt | Service | Settlement/Advisement | Critical |
| eService | Core Processing | Clearing/ | Highly |
| | Service | Settlement/Advisement | Critical |
| Treasury | Core Processing | Clearing/ | Highly |
| | Service | Settlement/Advisement | Critical |
| Global | Core Processing | Clearing/ | Highly |
| Clearing | Service | Settlement/Advisement | Critical |
| Mgt Sys | | | |
| Member | Product | Member Documentation | Critical |
| Publications | Services | | |
| Member | Product | Member Documentation | Critical |
| Bulletins | Services | | |

The recovery time objective (RTO) parameter 520 can include the desired time from implementation of a recovery plan to its completion. The RTO parameter 520 can be expressed as a discrete value, or a range of values, and in appropriate units, such as hours and/or days. The RTO parameter may also have zero value, i.e., immediate recovery.

When a user wishes to exclude system recovery plans from the calculation and/or analysis of plan metrics, the user can specify values for one or more of the plan parameters in the plan filter 510, and the tool 150 can include system recovery plans that have parameter values that match the values specified by the user. System recover plans that do not a have parameter values that match the values specified by the user are excluded from the calculation and/or analysis of plan metrics. As a result of the filtering, a subset of the system recovery plans can be included in the plan metrics and/or analysis displayed by the tool 150. The tool can identify the number of system recovery plans that are used for calculation and/or analysis of the plan metrics, and can identify a total number of the system recovery plans available.

When the scores and deliverables tab 532 is selected, the management unit of the tool 150 can calculate plan metrics for the system recovery plans based on a set of system recovery plans that have not been excluded from the calculation by the plan filter 510. As an example, the management unit of the tool can calculate the readiness of the system recovery plans based on evaluation results associated with the system recovery plans. The readiness of the system recovery plans can be defined as well prepared or recovery ready, reasonably prepared or workable, and under prepared or not recovery ready. In the present example, the readiness of the system recovery plans included in the metric calculation (e.g., system recovery plans that have not been excluded by the plan filter 510) can be displayed as a pie chart 540 that is divided into sections 542, 544, and 546 corresponding, respectively, to a percentage of plans that are well prepared or recovery ready, reasonably prepared or workable, and under prepared or not recovery ready.

As another example, the management unit 175 can identify readiness deliverables to be completed before one or more of the system recovery plans can be identified as being well prepared and/or reasonably prepared. The readiness deliverables can be displayed as a table 550 that includes a due date 552 for each of the deliverables, a plan code 554 associated with each of the deliverables, a deliverable description 556 providing a brief narrative description of the deliverables, and completion percentage 558 identifying a percentage of system recovery plans that have completed the deliverables.

A time and date 570 can be displayed to indicate a time and date that the last update to the system recovery plan information 135 occurred. The system recovery plan information 135 is updated, when the tool 150 accesses the RPS 110 to retrieve system recovery plan that has been modified, added, or otherwise changed since the last time the tool 150 retrieved the system recovery plan information 135. The tool 150 can automatically update the system recovery plan information 135 and/or can update the system recovery plan information 135 when requested by a user.

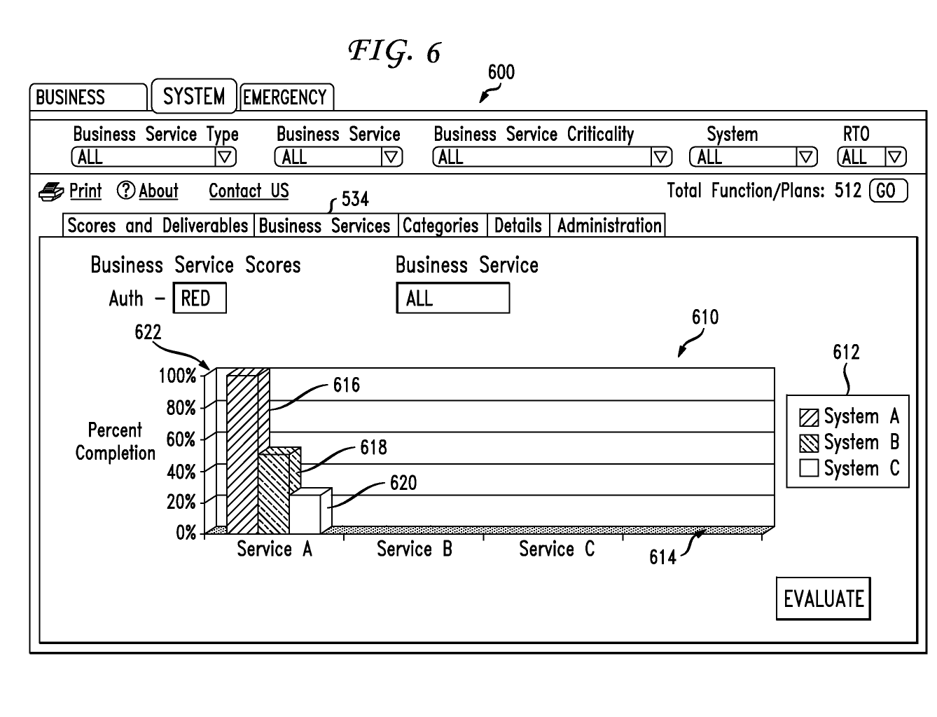

Referring now to FIG. 6, when the business services tab 534 is selected, a business services readiness view 600 can be presented. The management unit of the tool 150 can calculate plan metrics for the system recovery plans based on a set of system recovery plans that have not been excluded from the calculation by the plan filter 510 which are associated with one or more particular business services. For example, the business services readiness view 600 includes a bar graph 610, having legend 612. Along the x-axis 614 of the bar chart 610, system recovery plan readiness metrics, represented as bars 616, 618, 620, are grouped by one or more business services supported by the affected systems. Within each business service classification, system recovery plans are grouped according to the particular system with which they are concerned, e.g., System A, System B, System C. The readiness of one or more system recovery plans is calculated and aggregated for each system, and presented as bars 616, 618, 620. The height of each bar 616, 618, 620 against the y-axis 622 corresponds with the aggregate percent completion of the system recovery plans associated with each system, and each business service, respectively. Accordingly, the user can determine the readiness level associated within each system, and each business service, and direct preparation resources to plans most in need thereof according to a user-directed priority.

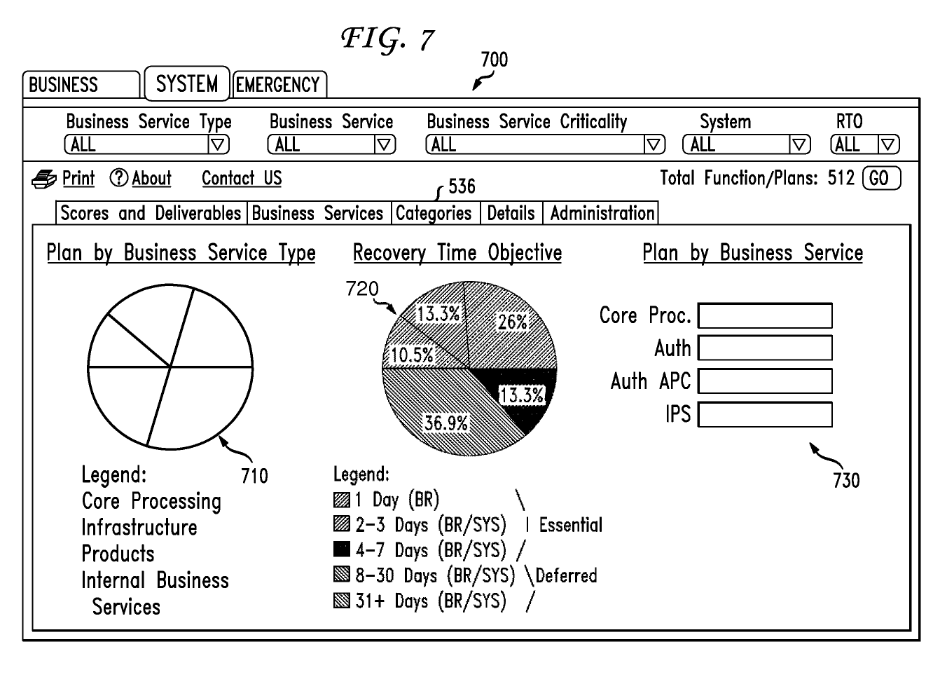

When the categories tab 536 is selected, a categorization view 700 can be displayed, as shown in FIG. 7. The categorization view 700 can separate the system recovery plans into categories using plan parameter. For example, the system recovery plans can be separated by parameter values for the business service type parameter, the business services parameter, the business service criticality parameter, the system parameter, the recovery time objective parameter, and the like. The recovery time objective parameter can identify an amount of time within which a recovery plan should be completed. For example, a business service criticality parameter value of essential may require a recovery time of less than 8 days, while a business service criticality parameter value of deferred may be associated with a recovery time of greater than or equal to 8 days.

In the present example, the system recovery plans have been separated using the business service type parameter, recovery time objective parameter, and the business services parameter. The distribution of system recovery plans for the business service type parameter can be displayed as a pie chart 710, in which the business service types associated with the system recovery plans can be represented in proportion based on a percentage calculated using the number of recovery plans associated with each of the business service types divided by a total number of system recovery plans that have not been excluded by the plan filter 510.

Likewise, the distribution of system recovery plans for the recover time objective parameter can be displayed as a pie chart 720, in which the recover time objectives associated with the system recovery plans can be represented in proportion based on a percentage calculated using the number of recovery plans associated with each of the recover time objectives divided by a total number of system recovery plans that have not been excluded by the plan filter 510.

The distribution of system recovery plans with respect to the business services parameter can be illustrated as a bar graph 730 identifying the business services and the number of system recovery plans that have not been excluded by the plan filter 510, which are associated with the plan categories.

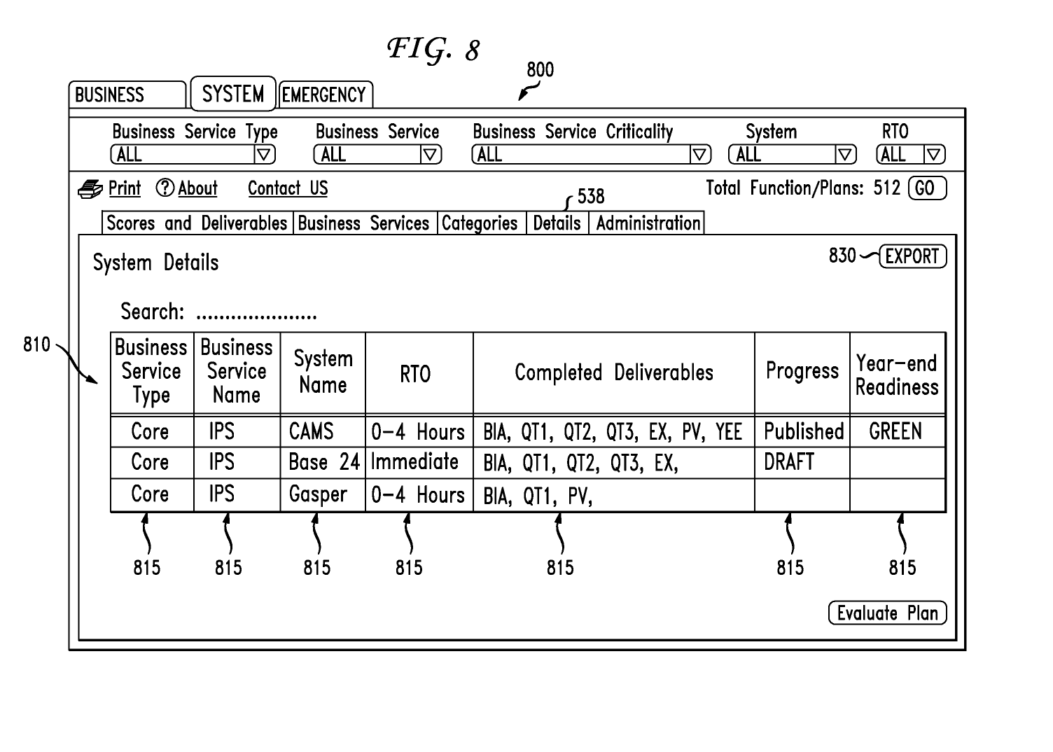

When the details tab 538 is selected, a details view 800 can be displayed, as shown in FIG. 8. The details view 800 can generate a table 810 of system recovery plans. The plan parameters form the columns 815 of the tables 810 and can include the business service type parameter, the business services parameter, the system parameter, recover time objective parameter, completed deliverables parameter, progress parameter, year-end readiness parameter, and the like. The system recovery plans can be sorted by the plan parameters, such that for example, the system recovery plans can be sorted by the business service type. The system recovery plans listed in the table 810 can be selectable to allow users to view the system recovery plans. The details view 800 can include an export button 830, which when selected exports the table 810 from the tool. The table 810 can be exported as a spreadsheet file, word processing file, presentation slide file (e.g., Microsoft PowerPoint®), a rich text file, an eXtensible Mark-up (XML) file, hypertext mark-up language (HTML) file, and the like.

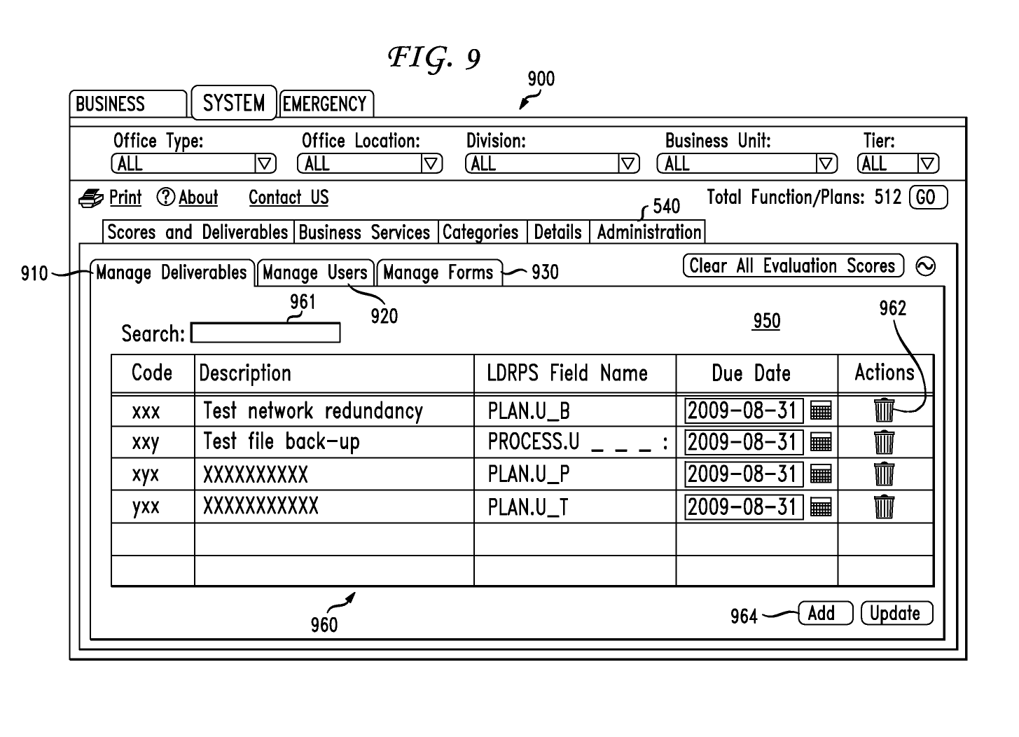

When the administration tab 540 is selected, an administrative view 900 specific to the system recovery plans can be displayed by the tool 150, as shown in FIG. 9. The administrative view 900 can be restricted to administrative users of the tool so that the administrator information 185 displayed in the administrative view 900 can be inaccessible to evaluators and/or restricted users. In some embodiments, administrative users can be restricted from accessing the administrative view of the system recovery plans, business recovery plans, and/or emergency management plans based on the administrative user's role, office location, and the like. The administrative view 900 can allow administrative users to manage deliverables associated with response plans, manage administrator information 185, such as user access and levels, manage evaluation forms, and the like. The administrative view 900 can include a manage deliverables tab 910 for displaying a deliverables view, a manage user tab 920 for displaying a user configuration view, and a manage forms tab 930 for displaying evaluation information.

When the manage deliverables tab 910 is selected by an administrative user, a deliverables sub-view 950 within the administrative view 900 can be displayed. The deliverables sub-view 950 can include a searchable table 960 of deliverables. The table can include deliverable parameters including codes that identify the deliverables, a description of the deliverables, an RPS field name for the deliverables, a due date of the deliverables, and actions that can be performed with respect to the deliverables. The administrative user can delete deliverables by selecting a “delete” button 962. Likewise, an administrative user can add a new deliverable to the table by selecting the “Add” button 964, which results in a add deliverables page (not shown) being displayed to the administrative user. The administrative user can assign due dates to the deliverables in the table 910, which can be used by the tool to monitor progress of recovery readiness and compliance with the deliverables. The table 910 can be searchable by entering search terms in a search field 961.

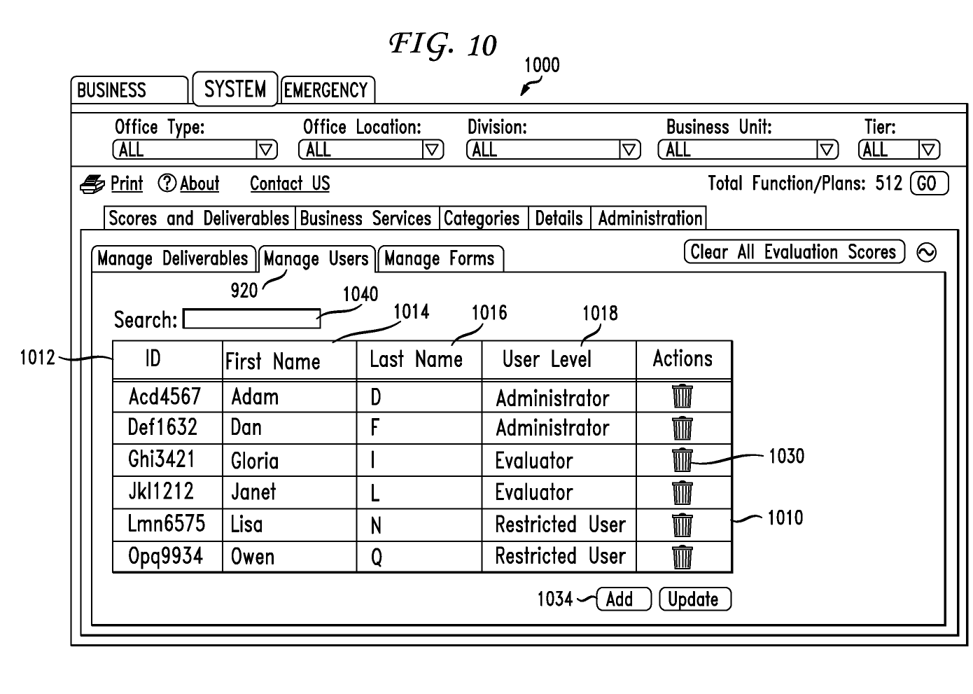

When the manage users tab 920 is selected, a user configuration sub-view 1000 within the administrative view 900 can be displayed, as shown in FIG. 10. The user configuration view 1000 can include a table 1010 of users that can access the tool 150. The table 1010 includes user information arranged in columns for user IDs 1012, first names 1014, last names 1016, and user level 1018. The administrative user can delete a user by selecting a “delete” button 1030. A user can add a new user to the table by selecting the “Add” button 1034, which results in a user profile page (not shown) being displayed to the administrative user. The administrative user can assign a user level to the users in the table 1010, which can be used by the tool to restrict user access to some, all, or none of the response plan information 105. The table 1010 can be searchable by entering search terms in a search field 1040.

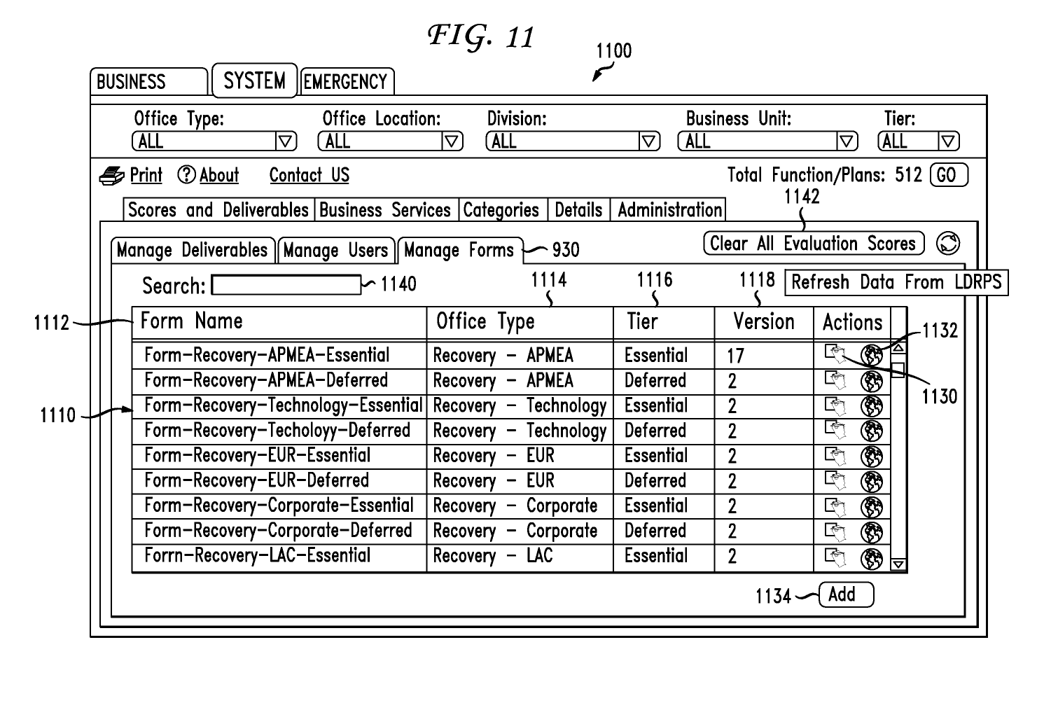

When the manage forms tab 930 is selected, an evaluation management sub-view 1100 can be displayed, as shown in FIG. 11. The user evaluation management view 1100 can include a table 1110 of evaluation forms created for evaluating response plans using the tool 150. The table 1110 can include a list of evaluation forms 1112, which can be associated with office types 1114, plan tiers 1116, and a version number 1118. The administrative user can modify user information by selecting a modify button 1130 and can clear evaluation information entered in the evaluation forms by selecting the clear button 1132. Clearing an evaluation form can reset the evaluation to its default form, and can be used to restart evaluations using the evaluation form. In some embodiments, the evaluation management view 1100 can include a “clear all evaluation scores” button 1142, which when selected, causes the tool to reset all of the evaluation forms associated with the system response plan information to their original or default settings. A user can add a new evaluation form to the table by selecting the “Add” button 1134, which results in a evaluation form page (not shown) being displayed to the administrative user. The table 1110 can be searchable by entering search terms in a search field 1140.

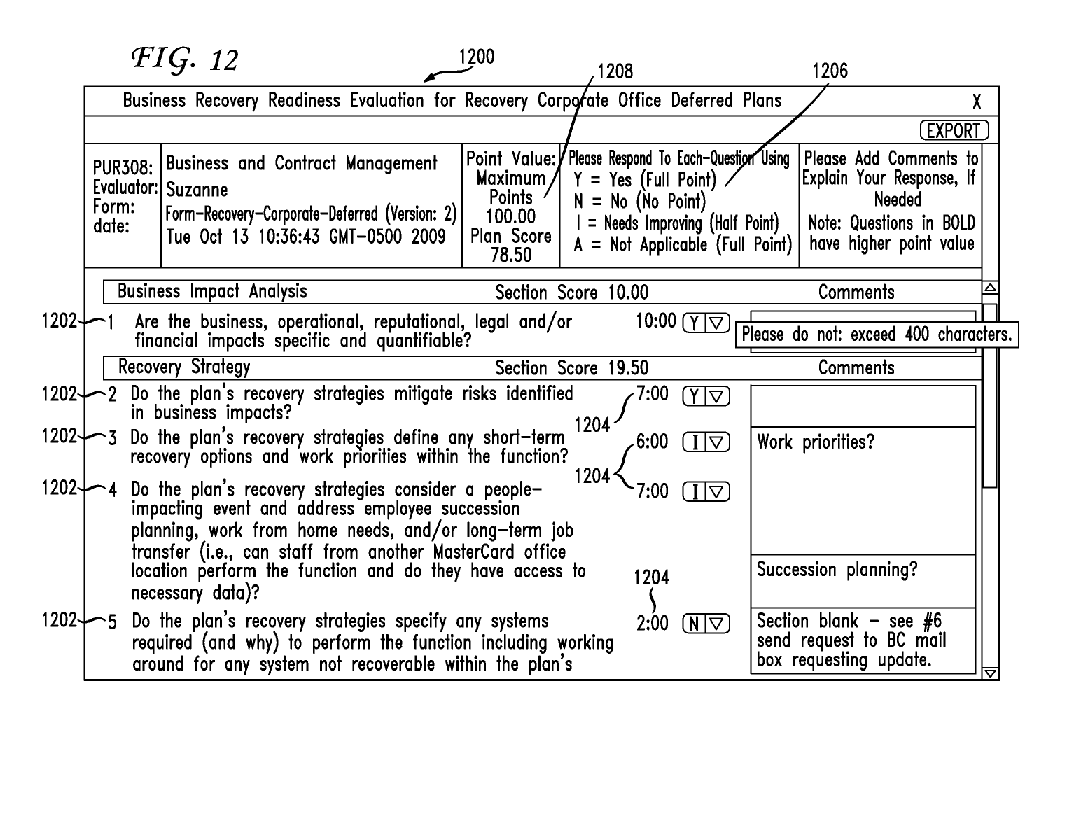

When the user chooses to edit an evaluation form and selects the modify button 1130 corresponding to one of the evaluation forms, the evaluation form 1200 can be displayed, as shown in FIG. 12. The evaluation form can include evaluation questions 1202, each of which are assigned a point value 1204. The points earned for each questions depends on the answer that is provided for the questions and can be determined according to a specified point allocation key 1206. The plan score 1208 is determined based on the accumulation of points received for each question. In the present example, the response plan corresponding to the evaluation form 1200 can receive a maximum of 100 points, and has a plan score of 78.50.

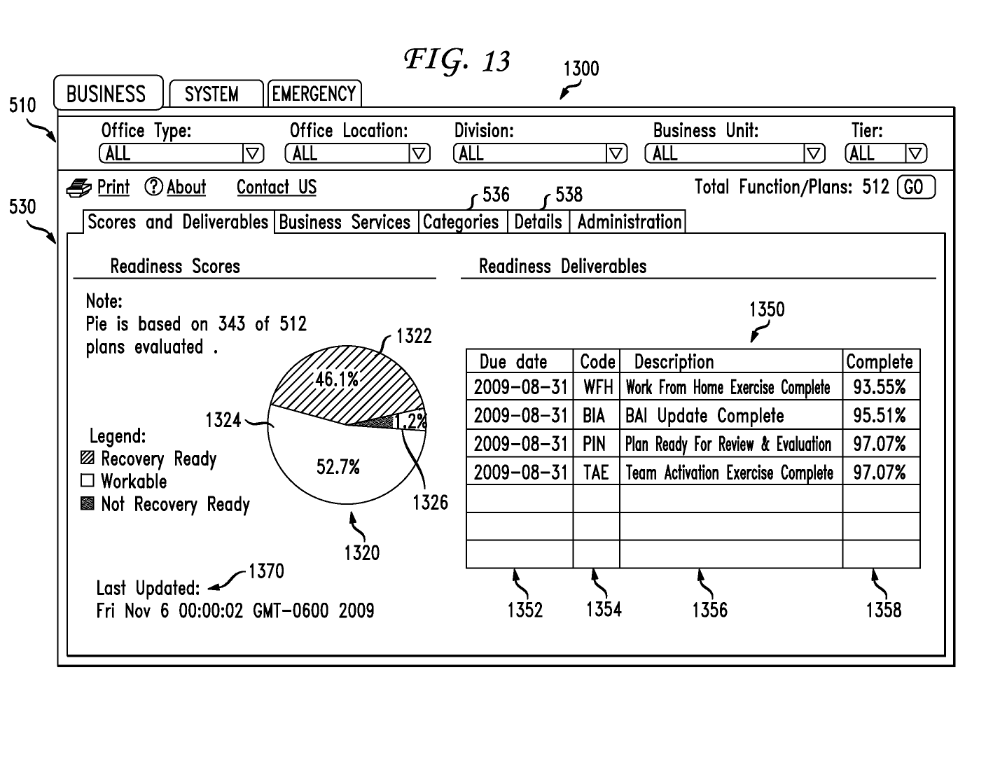

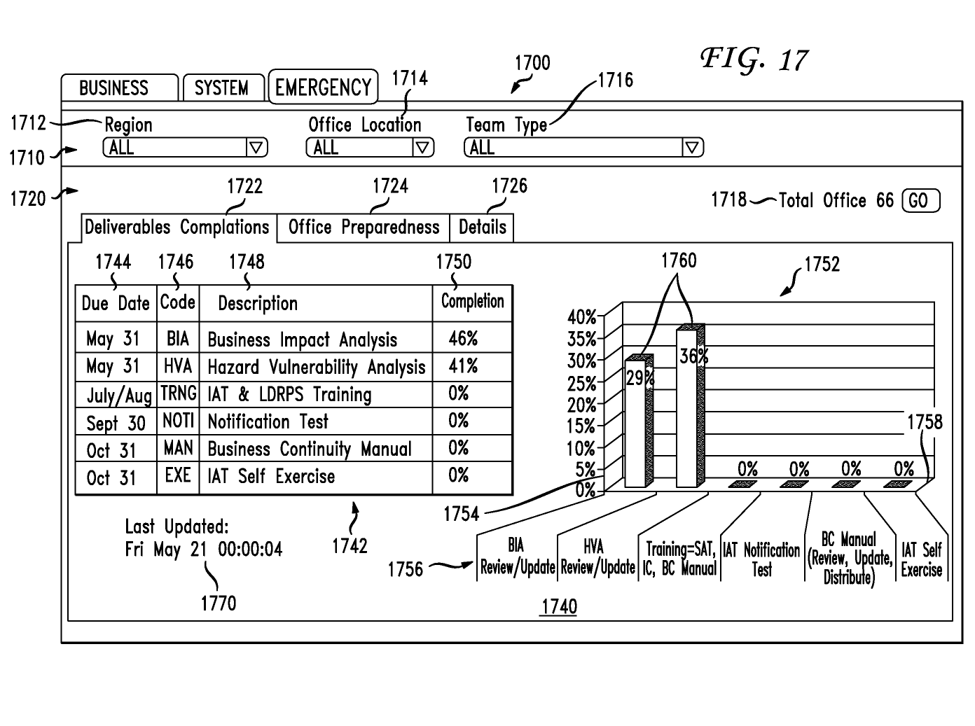

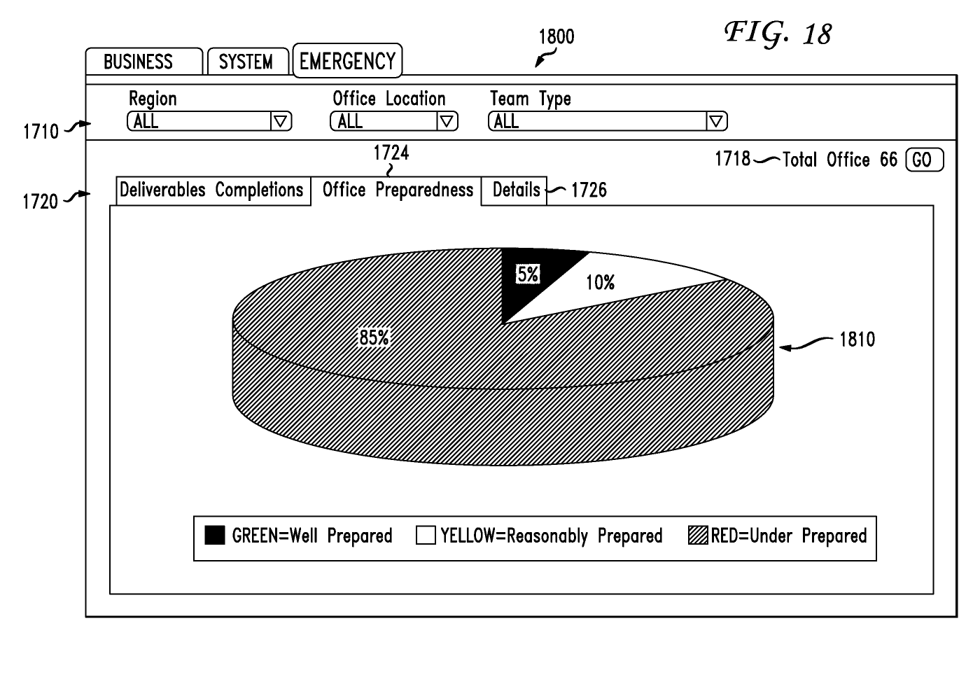

While the views in FIGS. 5-12 have been illustrated with respect to system recovery plan information 135, those skilled in the art will recognize that similar view can be implemented for business recovery plan information 125 and emergency management plan information 145. For example, FIGS. 13-16 are illustrative views that can be implemented for business recovery plan information 125 and FIGS. 17-19 are illustrative views that can be implemented for emergency management plan information 145.

FIGS. 13-16 illustrate an exemplary the business recovery view 1300 that can be displayed when the business recovery button 410 is selected by the user. The business recovery view 1300 displays business recovery plan information 125 and can include the plan filter 510 and sub view tabs 530. The plan filter 510 can filter recovery plans according to plan parameters to exclude business recovery plans that do not match the specified values for the plan parameters. In the present example, the readiness of the business recovery plans included in the plan metrics calculations (e.g., business recovery plans that have not been excluded by the plan filter 510) can be displayed as a pie chart 1320 that is divided into sections 1322, 1324, and 1326 corresponding, respectively, to a percentage of plans that are recovery ready, workable, and not recovery ready.

As another example, the management unit can identify readiness deliverables to be completed before one or more of the business recovery plans can be identified as being recovery ready and/or workable. The recovery deliverables can be displayed as a table 1350 that includes a due date 1352 for each of the deliverables, a plan code 1354 associated with each of the deliverables, a deliverable description 1356 providing a brief description of the deliverables, and completion percentage 1358 identifying a percentage of business recovery plans that have completed the deliverables. A time and date 1370 can be displayed to indicate the last time the business recovery plan information 125 was updated.

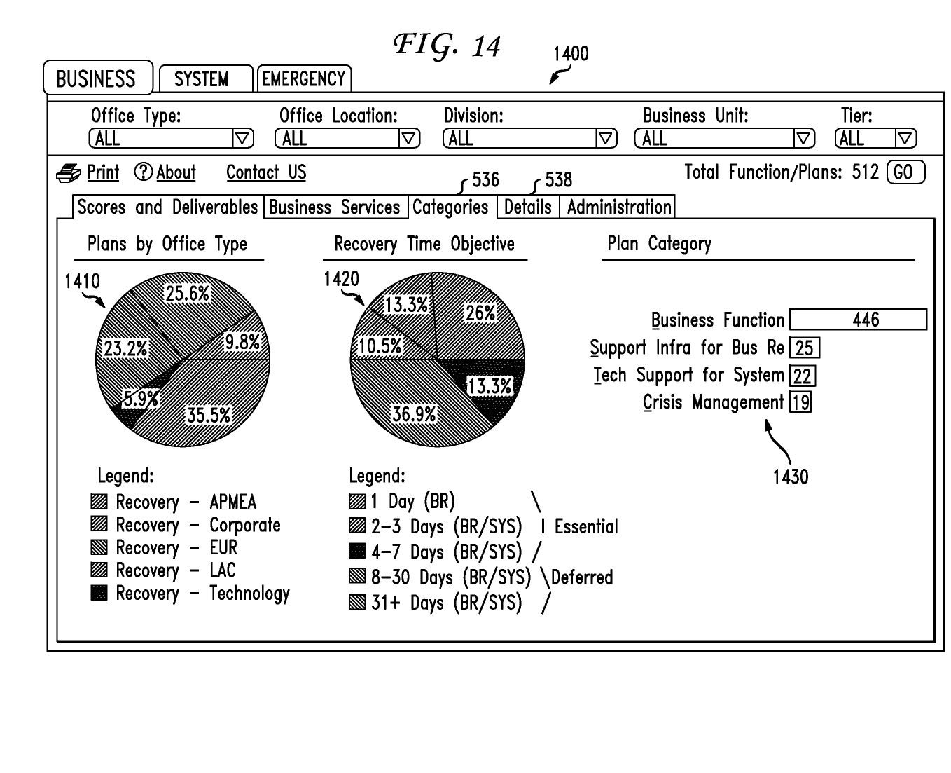

When the Categories tab 536 is selected, a categorization view 1400 can be displayed, as shown in FIG. 14. The categorization view 1400 can separate the business recovery plans into categories using plan parameters. For example, the business recovery plans can be separated by parameter values for the office type parameter, the office location parameter, the division parameter, the business unit parameter, the plan tier parameter, the recovery time parameter, an overall plan category parameter, and the like. The overall plan category parameter can identify function or operation for which the plan is generated. For example, business recovery plans can have overall plan categories, such as business function, support infrastructure, technical support, crisis management, and the like.

In the present example, the business recovery plans have been separated using the office type parameter, recovery time parameter, and the overall plan category parameter. The distribution of business recovery plans for the office type parameter can be displayed as a pie chart 1410, in which the office types associated with the business recovery plans can be represented in proportion based on a percentage calculated using the number of recovery plans associated with each of the office types divided by a total number of business recovery plans that have not been excluded by the plan filter 510.

The distribution of business recovery plans for the recovery time parameter can be displayed as a pie chart 1420, in which the recovery times associated with the business recovery plans can be represented in proportion based on a percentage calculated using the number of business recovery plans associated with each of the recovery times divided by a total number of business recovery plans that have not been excluded by the plan filter 510.

The distribution of business recovery plans with respect to the overall plan category parameter can be illustrated as a bar graph 1430 identifying the plan categories and the number of business recovery plans that have not been excluded by the plan filter 510, which are associated with the plan categories.

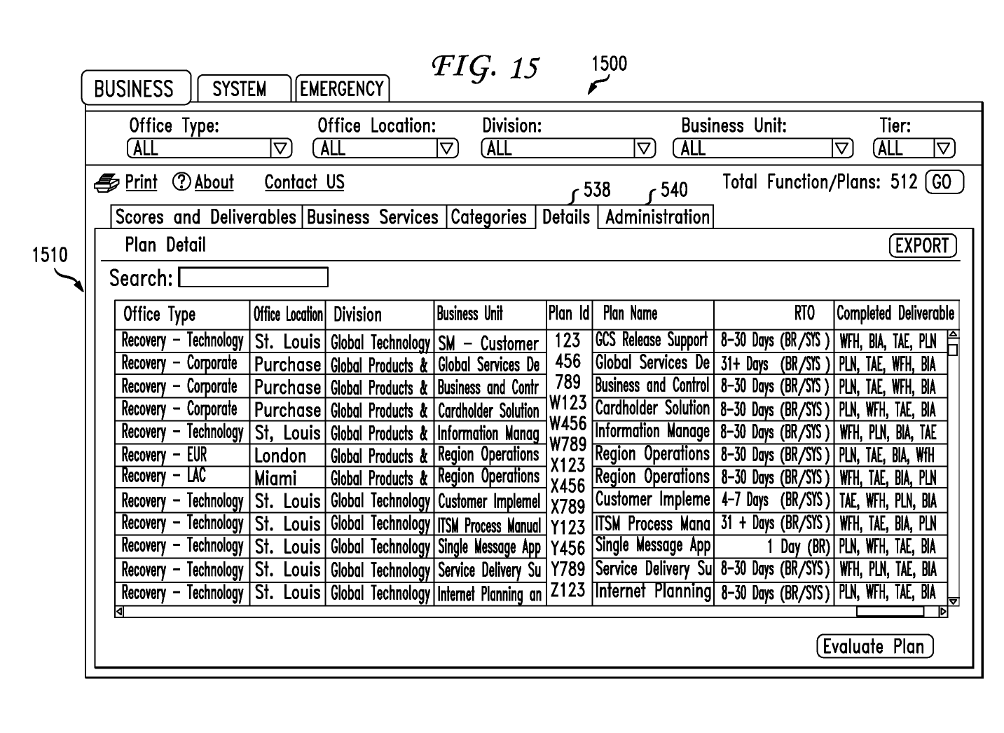

When the Details tab 538 is selected a details view 1500 can be displayed, as shown in FIG. 15. The details view 1500 can generate a table 1510 of business recovery plans. The plan parameters form the columns of the tables and can include the office type parameter, the office location parameter, the division parameter, business unit parameter, plan identifier (ID) parameter, plan name parameter, recovery time parameter, completed deliverables parameter, and the like.

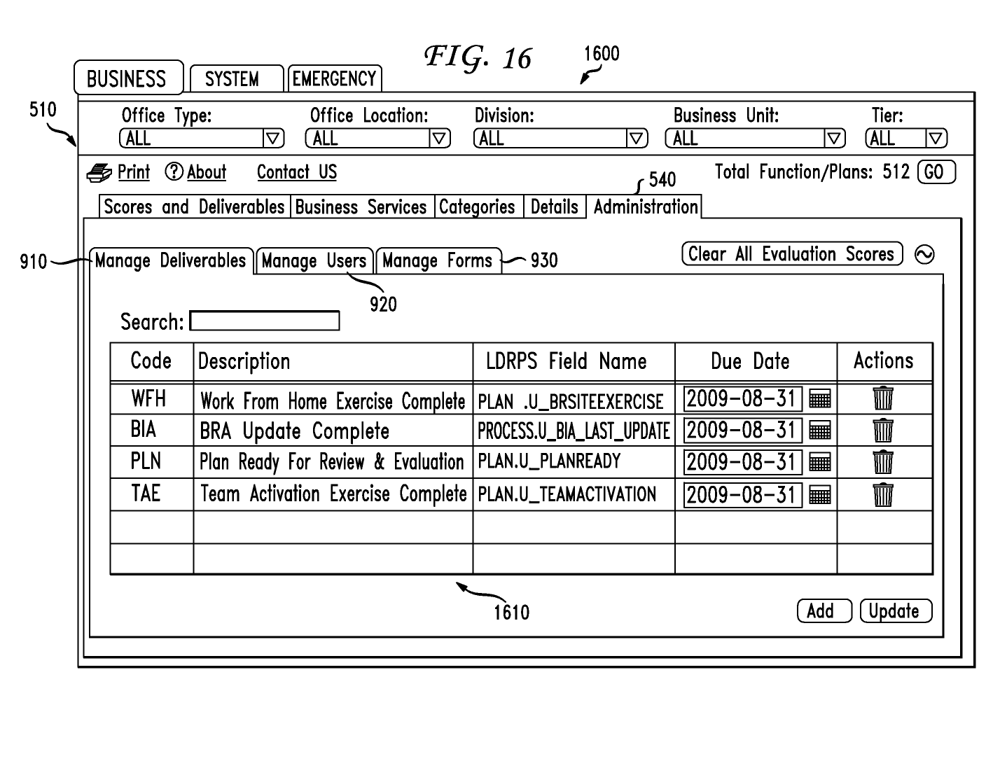

When the administration tab 540 is selected, an administrative view 1600 can be displayed by the tool 150, as shown in FIG. 16. The administrative view 1600 can be restricted to administrative users of the tool 150 so that the information displayed in the administrative view 1600 can be inaccessible to evaluators and/or restricted users. The administrative view 1600 can allow administrative users to manage deliverables associated with business recovery plans, manage configuration information, such as user access and levels, manage evaluation forms, and the like. The administrative view 1600 can include the manage deliverables tab 810, which in this example can display a deliverables table 1610, listing deliverable items associated with the business recovery plans that were not excluded by the plan filter 510, a manage user tab 820, which in this example can display a user configuration view (not shown) associated with the business recovery plans, and a manage forms tab 830, which in this example can display evaluation information (not shown) associated with the business recovery plans.

FIGS. 17-19 illustrate an exemplary the emergency management view 1600 that can be displayed when the emergency management button 414 is selected by the user. The emergency management view 1700 displays emergency management plan information 145 and can include the plan filter 1710 and sub view tabs 1720. The plan filter 1710 can filter emergency management plans according to plan parameters to exclude emergency management plans that do not match the specified values for the plan parameters. The plan filter 1710 can include a region filter 1712, an office location filter 1714, and a team type filter 1716. The emergency management view 1700 can also include a count 1718 of the number of offices associated with the emergency management plans not excluded by the plan filter 1710. The sub view tabs can include a deliverables completion tab 1722, an office preparedness tab 1724, and a details tab 1726.

When the deliverables completion tab 1722 is selected, a deliverables completion view 1740 can be displayed that includes a completion table 1742 and a bar graph 1752. The completion table can include a due date 1744 for each of the deliverables, a plan code 1746 associated with each of the deliverables, a deliverable description 1748 providing a brief description of the deliverables, and completion percentage 1750 identifying a percentage of the deliverable that has been completed. The y-axis 1754 of the bar graph 1752 represents a percent completion of deliverables for the emergency management plans 1756 indexed across the x-axis 1758 of the bar graph 1752. Bars 1760 of the bar graph 1752 can represent the level of completion of each plan. A time and date 1770 can be displayed to indicate the last time the business recovery plan information 125 was updated.

When the office preparedness tab 1724 is selected, an office preparedness view 1800 can be displayed, as shown in FIG. 18. The office preparedness view 1800 can include a pie chart 1810, in which the office preparedness can be represented in proportion based on a percentage of emergency management plans that are well prepared, reasonably prepare, and under prepared, among the emergency preparedness plans not excluded by the plan filter 1710. The office preparedness is calculated based on deliverables that have been completed. For example, the tool 150 can calculate office preparedness by dividing the number of completed deliverables by the total number of deliverables and multiplying the result by one hundred. In the present illustrated pie chart 1810, eight-five percent (85%) of the emergency management plans are under prepared, ten percent (10%) are reasonably prepared, and five percent (5%) are well prepared.

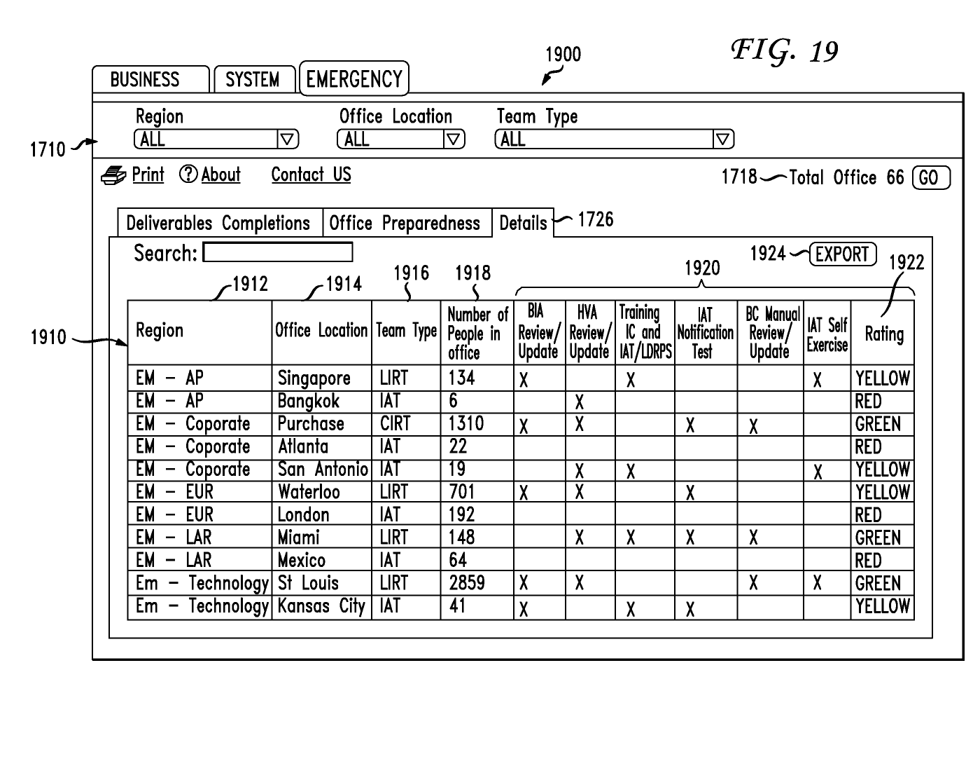

When the details tab 1726 is selected a details view 1900 can be displayed, as shown in FIG. 19. The details view 1900 can generate a table 1910 of emergency management plans. The columns of the tables can include the office region parameter 1912, the office location parameter 1914, team type parameter 1916, number of people at the office location 1918, and emergency plans to implemented 1920, and ratings 1922. Completion of the emergency management plans can be indicated for each office location in the table by checking or otherwise marking the columns corresponding to the emergency management plans. Entries in the rating column 1922 can include a level of completion of emergency management plans for each office in the table. For example, entries in the ratings column 1822 can be color coded and/or can include words, such as “yellow”, “red”, and “green”, where the color green or the word “green” can mean that the office location is well prepared, the color yellow or the word “yellow” can mean that the office location is reasonably prepared, and the color red or the word “red” can mean that the office location is under prepared. An export button 1924 can allow the user to export the data reflected in the table 1910 in a variety of forms. The table 1910 can be exported as a spreadsheet file, word processing file, presentation slide file (e.g., Microsoft PowerPoint®), a rich text file, an eXtensible Mark-up (XML) file, hypertext mark-up language (HTML) file, and the like.

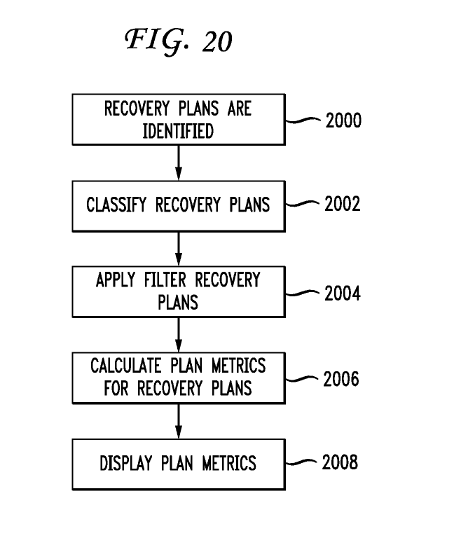

FIG. 20 is a flowchart illustrating an exemplary plan metrics analysis using the tool 150 described herein. According to the disclosed analysis, recovery plans are identified 2000. Each recovery plan thus identified is classified 2002 as one of a business recovery plan, a system recovery plan, or a system recovery plan. A filter can be applied 2004 to some, all, or none of the identified and classified recovery plans to exclude certain recovery plans from calculations of plan metrics associated with other recovery plans. For example, plan metrics for system recovery plans can be calculated after system recovery plans that do not match the criteria specified in the plan filter are excluded. The tool 150 can calculate plan metrics 2006 for a combination of the business recovery plans, system recovery plans, and emergency management plans, and/or can calculate plan metric separately for the business recovery plans, system recovery plans, and emergency management plans. The calculated plan metrics can be displayed 2008 to a user. In some embodiments, the plan metrics for the business recovery plans, system recovery plans, and emergency management plans can be calculated and displayed separately and/or independently. In some embodiments, plan metrics for the business recovery plans, system recovery plans, and emergency management plans can be calculated and displayed in a combined and integrated manner such that overall enterprise recovery plan information can be provided.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for managing response plans of an enterprise comprising:
identifying response plans for the enterprise, including business recovery plans relating to business aspects of the enterprise, system recovery plans relating to technology aspects of the enterprise, and emergency management plans relating to emergencies affecting the enterprise;
evaluating the business recovery plans, system recovery plans, and emergency management plans, the evaluating including
calculating plan metrics for the business recovery plans, system recovery plans, and emergency management plans independently and separately from each other, the plan metrics being calculated in response to an evaluation of the business recovery plans, the system recovery plans, and the emergency management plans; and
determining a readiness of the business recovery plans, the system recovery plans, and the emergency management plans based on the plan metrics.

2. The method of claim 1, wherein evaluation further comprises at least one of:
filtering the business recovery plans using a first plan filter, based on plan parameters associated with the business recovery plans, and disregarding a portion of the business recovery plans excluded by the filtering from the calculating of plan metrics;
filtering the system recovery plans using a second plan filter, based on plan parameters associated with the system recovery plans, and disregarding a portion of the system recovery plans excluded by the filtering from the calculating of plan metrics; and
filtering the emergency management plans using a third plan filter, based on plan parameters associated with the emergency management plans, and disregarding a portion of the emergency management plans excluded by the filtering from the calculating of plan metrics.

3. The method of claim 2, wherein calculating plan metrics for the system recovery plans comprises:
identifying evaluation results for response plans that have not been excluded by one of the plan filters;
classifying evaluated response plans as one of recovery ready, workable, or not recover ready based on the evaluation results; and
calculating a percentage of the response plans that are recovery ready, workable, and not recovery ready using the response plans that have not been excluded by the plan filter.

4. The method of claim 1, wherein evaluating further comprises:
generating evaluation forms for the business recovery plans, system recovery plans, and emergency management plans, the evaluation forms including questions;
assigning a point values to the questions; and
calculating plan scores for the business recovery plans, system recovery plans, and emergency management plans based on the assigned point values for the questions and the responses to the questions from one or more evaluators completing the evaluations forms.

5. The method of claim 4, further comprising:
specifying a first range of plan scores that correspond to a designation of recovery ready;
specifying a second range of plan scores that correspond to a designation of workable;
specifying a third range of plan scores that correspond to a designation of not recovery ready; and
classifying the plan scores calculated for the business recovery plans, system recovery plans, and emergency management plans based on the ranges of plan scores.

6. The method of claim 1, further comprising:
displaying the plan metrics using at least one of a chart, table, and graph.

7. The method of claim 1, further comprising:
restricting access to the plan metrics based on a user level assigned to a user requesting access.

8. A non-transitory computer readable medium storing instructions executable by a computing system including at least one computing device, wherein execution of the instructions implements a method for managing response plans of an enterprise comprising:
identifying business recovery plans, system recovery plans, and emergency management plans for the enterprise, the business recovery plans relating to business aspects of the enterprise, the system recovery plans relating to technology aspects of the enterprise, and the emergency management plans relating to emergencies affecting the enterprise;
generating an evaluation schema for the business recovery plans, system recovery plans, and emergency management plans, the evaluation schema including
calculating plan metrics for the business recovery plans, system recovery plans, and emergency management plans independently and separately from each other, the plan metrics being calculated in response to an evaluation of the business recovery plans, the system recovery plans, and the emergency management plans; and
determining a readiness of the business recovery plans, the system recovery plans, and the emergency management plans based on the evaluation.

9. The medium of claim 8, wherein the method implemented by the execution of the instructions further comprises:
filtering the business recovery plans using a plan filter, the filtering being based on plan parameters associated with the business recovery plans and excluding a portion of the business recovery plans from the calculating of plan metrics;
filtering the system recovery plans using a plan filter, the filtering being based on plan parameters associated with the system recovery plans and excluding a portion of the system recovery plans from the calculating of plan metrics;
filtering the emergency management plans using a plan filter, the filtering being based on plan parameters associated with the emergency management plans and excluding a portion of the emergency management plans from the calculating of plan metrics;

10. The medium of claim 9, wherein calculating plan metrics for the system recovery plans comprises:
identifying evaluation results for system recovery plans that have not been excluded by the plan filter;
classifying a number of system recovery plans identified as recovery ready based on the evaluation results;
classifying a number of system recovery plans identified as workable based on the evaluation results;
classifying a number of system recovery plans identified as not recovery ready based on the evaluation results; and
calculating a percentage of system recovery plans that are recovery ready, workable, and not recovery ready using the system recovery plans that have not been excluded by the plan filter

11. The medium of claim 8, wherein generating an evaluation schema for the business recovery plans, system recovery plans, and emergency management plans comprises:
generating evaluation forms for the business recovery plans, system recovery plans, and emergency management plans, the evaluation forms including questions;
assigning respective point values to the questions; and
calculating plan scores for the business recovery plans, system recovery plans, and emergency management plans based on the point values received for the questions.

12. The medium of claim 11, wherein the method implemented by the execution of the instructions further comprises:
specifying a range of plan scores that correspond to a designation of recovery ready;
specifying a range of plan scores that correspond to a designation of workable;
specifying a range of plan scores that correspond to a designation of not recovery ready; and
classifying the plan scores calculated for the business recovery plans, system recovery plans, and emergency management plans based on the ranges of plan scores.

13. The medium of claim 8, wherein the method implemented by the execution of the instructions further comprises:
displaying the plan metrics using at least one of a chart, table, and graph.

14. The medium of claim 13, wherein the method implemented by the execution of the instructions further comprises:
restricting access to the plan metrics based on a user level assigned to a user requesting access.

15. A system managing response plans of an enterprise comprising:
a computing system including at least one computing device having a processor; and
a non-transitory machine-readable storage medium having a program of instruction thereon, the program of instruction which, when executed by the processor, cause the computing system to:
identify business recovery plans, system recovery plans, and emergency management plans for the enterprise, the business recovery plans relating to business aspects of the enterprise, the system recovery plans relating to technology aspects of the enterprise, and the emergency management plans relating to emergencies affecting the enterprise;
generate an evaluation schema for the business recovery plans, system recovery plans, and emergency management plans, the evaluation including
calculating plan metrics for the business recovery plans, system recovery plans, and emergency management plans independently and separately from each other, the plan metrics being calculated in response to an evaluation of the business recovery plans, the system recovery plans, and the emergency management plans; and
determining a readiness of the business recovery plans, the system recovery plans, and the emergency management plans based on the evaluation.

16. The system of claim 15, wherein the program of instruction, when executed by the processor, further causes the computing system to:
filter the business recovery plans using a plan filter, the filtering being based on plan parameters associated with the business recovery plans and excluding a portion of the business recovery plans from the calculating of plan metrics;
filter the system recovery plans using a plan filter, the filtering being based on plan parameters associated with the system recovery plans and excluding a portion of the system recovery plans from the calculating of plan metrics;
filter the emergency management plans using a plan filter, the filtering being based on plan parameters associated with the emergency management plans and excluding a portion of the emergency management plans from the calculating of plan metrics;

17. The system of claim 16, wherein the program of instruction, when executed by the processor, further causes the computing system to:
identify evaluation results for system recovery plans that have not been excluded by the plan filter;
classify a number of system recovery plans identified as recovery ready based on the evaluation results;
classify a number of system recovery plans identified as workable based on the evaluation results;
classify a number of system recovery plans identified as not recovery ready based on the evaluation results; and
calculate a percentage of system recovery plans that are recovery ready, workable, and not recovery ready using the system recovery plans that have not been excluded by the plan filter

18. The system of claim 15, wherein the program of instruction, when executed by the processor, further causes the computing system to:
generate evaluation forms for the business recovery plans, system recovery plans, and emergency management plans, the evaluation forms including questions;
assign a point values to the questions; and
calculate plan scores for the business recovery plans, system recovery plans, and emergency management plans based on the point values received for the questions.

19. The system of claim 18, wherein the program of instruction, when executed by the processor, further causes the computing system to:
specifying a range of plan scores that correspond to a designation of recovery ready;
specifying a range of plan scores that correspond to a designation of workable;
specifying a range of plan scores that correspond to a designation of not recovery ready; and
classifying the plan scores calculated for the business recovery plans, system recovery plans, and emergency management plans based on the ranges of plan scores.

20. The system of claim 15, wherein the program of instruction, when executed by the processor, further causes the computing system to display the plan metrics using at least one of a chart, table, and graph.
